(19) United States
(12) Patent Application Publication
(10) Pub. No.: US 2010/0186337 A1
(43) Pub. Date: Jul. 29, 2010

(54) Prefinished bonded leather paneling system

(76) Inventor: Peter M. Barretto, Gormley (CA)

Correspondence Address: GOWLING, LAFLEUR HENDERSON LLP, ONE MAIN STREET WEST, HAMILTON, ON, L8P 4Z5, CA

(21) Appl. No.: 12/320,555

(22) Filed: Jan. 29, 2009

(51) Int. Cl. E04B 2/32; B32B 21/04

(52) U.S. Cl. 52/588.1; 428/332

(57) ABSTRACT

A Paneling system for tiling a flat surface such as a floor or wall. Each panel comprises a core board with a prefinished leather layer fixed to the top surface and a backing layer, such as agglomerated cork, fixed to the bottom surface. The panels can be joined together using systems such as tongue and groove systems, joinery clip systems or uniclic systems.

### FIELD OF THE INVENTION

The present invention relates to a paneling system for floors and walls and in particular to a paneling system with a leather surface.

### BACKGROUND OF THE INVENTION

Natural leather floors have been known and used for some time. The raw material supply necessary for manufacturing natural leather floors can be very limited. The manufacture and installation of natural leather floors can also be very specialized and thus also not easily available.

One drawback of natural leather floors is that they scuff and mark easily and are therefore extremely difficult to maintain in relation to other known floors such as laminate or hardwood. Further, natural leather floors are one of the most expensive floors on the market.

Natural leather floors are therefore restricted to a minute sub-section of the market. Many consumers may not even know that natural leather floors exist.

Glue-down tiles are known in the art. Glue-down flooring is not easily removed nor is it easy to move to a different location after it has been glued down. Professional installation may also be required.

Bonded leather is a product known in the art since at least the early 1900s when it was produced in Europe. It comes from the process of using post-industrial scrap natural leather and grinding it down to fibre state. The fibres are then bonded back together with natural latex and various chemicals to form a bonded leather rolled good. The rolled goods are either sold as is or are coloured or textured to be sold into various original equipment manufacturer applications. The scrap natural leather may come from various tanneries, leather shoe/furniture/giftware/clothing manufacturers as well from the left over leather from the automotive industry. Bonded leather was predominately used in the footwear industry and has recently evolved into the giftware, furniture and clothing industries. Bonded leather has most recently been used in various architectural applications and recently in glue-down site-finished flooring.

A limited amount of glue-down bonded leather flooring has been sold on the market over the past few years. However, these bonded floors has had limited commercial success due to the problems discussed below.

The bonded leather flooring was not stable which caused the floor to cup, curl and shrink. It is difficult to find proper adhesives to prevent these issues and to prevent the lifting of the adhered tile to the sub-floor. Further, costly sub-floor preparation is required to make the sub-floor surfaces suitable for bonded leather flooring tile to adhere and not peak around the edges.

Hydrostatic pressure found in most concrete sub-floors makes glue down tiles very problematic in that they may blow off the floor.

Bonded leather floors are only partially finished and must have the final finish applied on site, creating a multitude of problems. Getting an experienced finisher, having the right finish, having it finished properly, having the right site conditions for the finish to cure properly, having the site protected from airborne dust and dirt that can contaminate the finish are just some of the challenges.

If a bonded leather floor fails it can be extremely costly to repair and can cause anywhere from two to five time the material cost in liability due to the costly removal or disposal of the faulty material, additional sub-floor preparation required, cost of replacement material, and new installation costs plus a wide variety of additional incidental costs that arise from not being able to utilize the site for upwards of a week.

Prefinish technology (i.e. prefinishing floors in the factory or before installation) has been introduced in hardwood flooring over the past three decades. The vast majority of floors sold in the world are now prefinished rendering site finish as a niche specialty business.

Overall, the sales of bonded leather flooring have been curtailed due to the costs, hassles and high product liability associated with the gluing down and site finishing of bonded leather floors.

The expense associated with tying up the site to glue down and then finish the product on site is significant and substantially raise costs. The time required may prevent the product from being specified in the first place.

Flooring can be manufactured and sold in panels or tiles for installation using a uniclic, joinery clip or tongue and groove system as is known to those familiar in the art.

The invention disclosed herein addresses at least one of the above problems.

### SUMMARY

One aspect of the present invention is a panel for tiling a flat surface, comprising a core board having an upper surface and a lower surface; a leather layer having a front surface and a back surface, the back surface fixed to the upper surface of the core board, and a backing layer fixed to the lower surface of the core board and extending away from the core board for facing the flat surface.

A further aspect of the present invention is a panel system for tiling a flat surface using a panel, the panel comprising a core board having an upper surface and a lower surface; a leather layer having a front surface and a back surface, the back surface fixed to the upper surface of the core board, and a backing layer fixed to the lower surface of the core board and extending away from the core board for facing the flat surface, the panel system comprising a first panel; and, a second panel joined to the first panel using a tongue and groove system, wherein the backing layer of the first panel faces the flat surface and the backing layer of the second panel faces the flat surface.

### BRIEF DESCRIPTION OF THE DRAWINGS

In order that the subject matter may be readily understood, embodiments are illustrated by way of examples in the accompanying drawings, in which:

FIG. 1 is a sectional view through the thickness of two bonded leather tiles attached showing detail of a uniclic click-joint system;

FIG. 2 is a plan view showing two panels according to the present invention used for covering a surface;

FIG. 3 is a plan view showing panels according to the present invention of different dimensions joined together to cover a surface; and

FIG. 4 is a plan view corresponding to FIG. 3 but showing shows panels of different dimensions from those of FIG. 3 joined together to cover a surface.

### DETAILED DESCRIPTION

Disclosed is a panel with a leather front surface for tiling flat surfaces such as floors and walls.

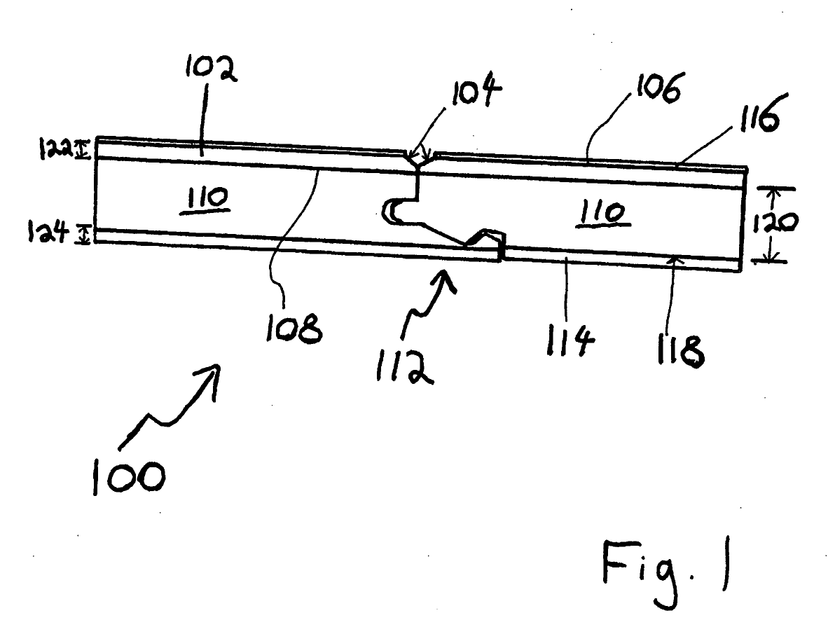

Referring to FIG. 1, a panel 100 is provided having three layers, namely a core board 110, a backing layer 114 fixed to one surface of the core board 110 and a leather layer 102 fixed to the opposite surface of the core board 110.

The core board 110 may be a low-swell high-density fiberboard of a thickness 120 between 6 mm to 15 mm. Alternatively, the core board 110 may be described as a moisture resistant high density wood fiber. By way of further alternative, the core board 110 can be of plywood or natural wood.

It is recognized that the core board can comprise other suitable material, although the material is preferably moisture resistant, low swell and strong enough to use with a uniclic or other tongue and groove system.

The leather layer 102 is preferably manufactured from bonded leather. It may, for example be high density bonded leather having a thickness 122 from 1 mm to 6 mm. A front surface 106 of the leather layer 102 facing away from the core board 102 may be embossed with a texture either via an embossing roller or plates (not shown) as is known to those skilled in the art. The textured surface may be painted with a multi-coat system of colours, with fade resistant, non-toxic coatings.

A non-“volatile organic compound” (non-VOC) adhesive may be used to securely bond the leather layer 102 to the core board 110. This will preferably prevent any movement or de-lamination. Depending on the adhesive used to bond the leather layer 102 to the core board 110, special time requirements may be required to stabilize the adhesion. Such time requirements are known to those familiar with bonding and adhesive mixtures.

A finish 116 may be applied to the surface 106 of the leather layer 102. For example, a nano-technology finish of 3 to 5 coats of water-based wear-resistant finish may be applied. The finish preferably does not have VOCs. The finish may for example be a scratch resistant urethane applied to the surface 106 in multiple coats. Preferably the finish is such that it will not fracture should the surface of the panel be impacted by a force such as a high heel.

The finish 116 can be applied during manufacturing of the panels. Alternatively the finish can be applied after the panels are installed.

A backing layer 114 may be fixed to the surface 118 of the core board 110 opposite the leather layer 102. The backing layer 114 may be a post-industrial recycled agglomerated cork having a thickness 124 ranging from 0.5 mm to 6 mm. The cork backing layer 114 provides stabilization of the panel and prevents warping and cupping by providing further structural integrity to the panel. Further, the cork backing provides sound and temperature insulation.

By way of further alternative, the backing layer 114 can be foam or leather, or other materials with sound or temperature insulation properties.

Panels 110 may be joined using a uniclic system 112 (as shown in FIG. 1), joinery clip system, a tongue and groove system or other methods or systems for attaching floating floor panels known in the art. However the core board 110 material along with the dimensions of the panels 100 should be such that the panels withstand the pressures applied when connected to and during connection with adjacent panels 100. The use of such a joining system allows for easy installation, removal, replacement and reuse of panels. The panels can also be installed on, above or below grade.

Micro bevel edges 104 may be used to prevent peaking, edge lipping or edge wear. Alternatively, square edges (not shown) may be used on low level embossed patterns.

It is recognized that the described paneling system can be used on other surfaces besides floors, such as walls.

It is also recognized that the floating floor system (e.g. the uniclic, joinery clip or tongue and groove system) can be used alone or together with a glue down floor or glue down surface covering.

A further aspect of the present invention is that panels of different dimensions may be combined on the same surface. As long as the respective dimensions of one size of panel are multiples of the dimensions of another panel size those two panels may be used to cover the same surface.

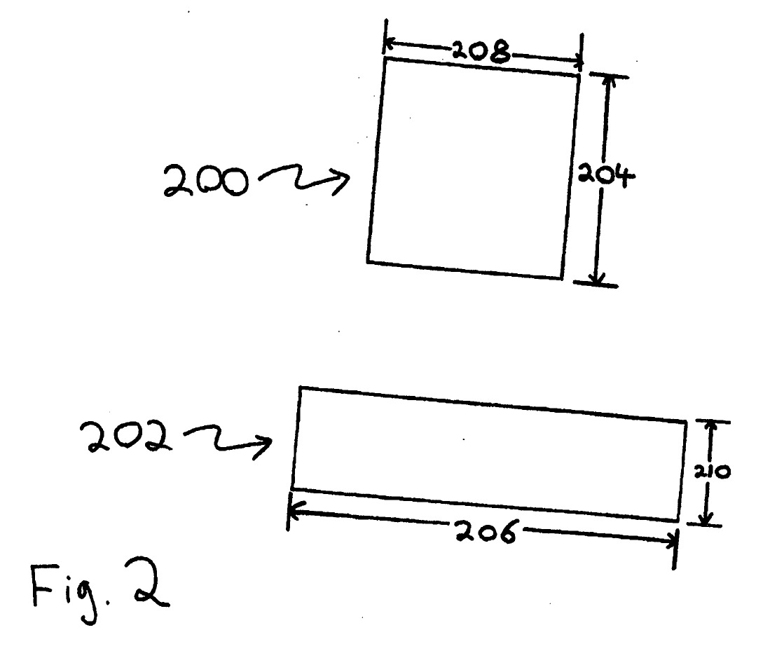

For example, FIG. 2 shows possible configurations of two panels 200, 202 that can be used to cover one surface. The width 204 of panel 200 is one half the width 206 of panel 202. Further, the length 208 of panel 200 is two time the length 210 of panel 202.

For example, the size of a first panel may be 10.5 mm×388 mm×388 mm or approximately ⅜″×15¼″×15¼″; and the size of a second panel may be 10.5 mm×194 mm×1164 mm or approximately ⅜″×7⅝″×45⅜″.

By way of further example a first panel may range from a size of 6″×6″ to 30″×30″; and a second panel may range from 4″×12″ to 24″×72″. Using a second panel of a multiple dimension to the first panel, a surface may be covered in panels using at least one of the selected second panel size and one of the selected first panel size.

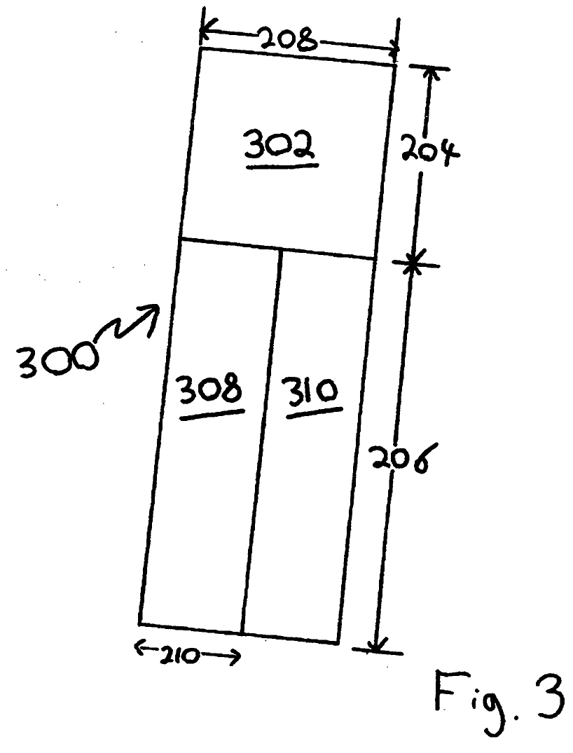

FIG. 3 shows one embodiment where panels of two different sizes are covering a surface 300. The length 210 of panels 308, 310 together is such that it is the same as the length 208 of panel 302 so that the surface section can be adequately covered using the two sizes of panels.

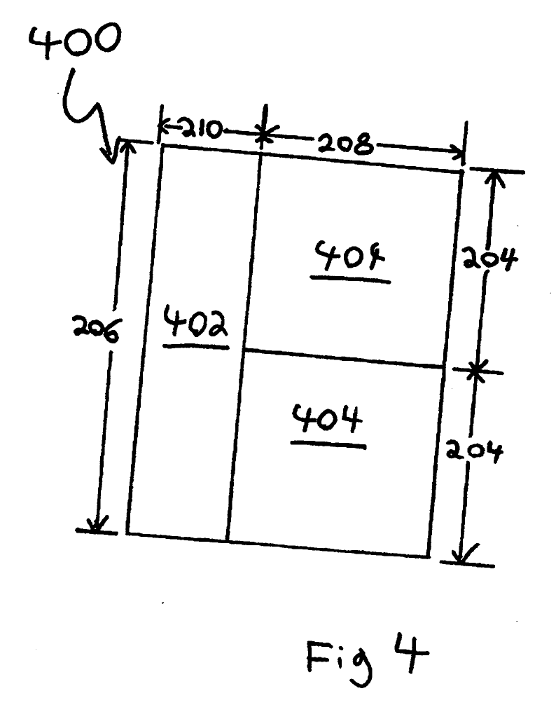

Similarly FIG. 4 shows another embodiment where panels of two different sizes are covering a surface 400. The width 206 of one panel 402 is the same as the combined width 204 of each of panels 404.

It is recognized that other similar combinations of different sized panels can be used to cover a surface.

Numerous modifications, variations, and adaptations may be made to the particular embodiments of the invention described above without departing from the scope of the invention which is defined in the claims.

What is claimed is:

1. A panel for tiling a flat surface, comprising:
a core board having an upper surface and a lower surface;
a leather layer having a front surface and a back surface, the back surface fixed to the upper surface of the core board, and
a backing layer fixed to the lower surface of the core board and extending away from the core board for facing the flat surface.

2. The panel of claim 1 wherein the core board comprises wood.

3. The panel of claim 1 wherein the core board comprises moisture resistant high density wood fiber.

4. The panel of claim 1 wherein the core board comprises low-swell, high density fiberboard.

5. The panel of claim 1 wherein the distance between the upper surface and the lower surface of the core board is between 6 millimeters and 15 millimeters.

6. The panel of claim 1 wherein the leather layer comprises bonded leather.

7. The panel of claim 1 wherein the distance between the upper surface of the core board and the front surface of the leather layer is between 1 millimeter and 6 millimeters.

8. The panel of claim 1 further comprising:
a layer of finish adhering to the front surface of the leather layer.

9. The panel of claim 8 wherein the layer of finish comprises between 2 to 10 coats of scratch resistant urethane for protecting the leather layer from staining, wearing and fading.

10. The panel of claim 8, the layer of finish comprising a nano-technology finish of between three and five coats of water-based wear resistant finish.

11. The panel of claim 1, the backing layer comprising foam.

12. The panel of claim 1, the backing layer comprising leather.

13. The panel of claim 1, the backing layer comprising agglomerated cork.

14. The panel of claim 13 wherein the cork extends from between 0.5 millimeters and 0.6 millimeters from the bottom surface of the core board.

15. A panel system for tiling a flat surface using the panels defined in claim 1, comprising:
a first panel; and,
a second panel joined to the first panel using a tongue and groove system,
wherein the backing layer of the first panel and the backing layer of the second panel rest on the flat surface.

16. The panel system of claim 15 wherein the first panel and the second panel have beveled edges for preventing peaking, edge lipping or edge wear.

17. The panel system of claim 15 wherein the flat surface comprises a floor.

18. The panel system of claim 15 wherein the first panel and the second panel are rectangular.

19. The panel system of claim 18 wherein the dimension of the front surface of the leather layer of the first panel is between 6 inches by 6 inches and 30 inches by 30 inches, the dimension of the front surface of the leather layer of the second panel is between 4 inches by 12 inches and 24 inches by 72 inches.

20. The panel system of claim 18 wherein the panels have dimensions which are whole multiples of dimensions of each other to enable joining of odd numbers of panels into rectangular arrangements.
